(19) United States
(12) Patent Application Publication
(10) Pub. No.: US 2024/0154490 A1
(43) Pub. Date: May 9, 2024

(54) ELECTRIC DRIVE UNIT FOR AN AIRCRAFT

(71) Applicant: Rolls-Royce Deutschland Ltd & Co KG, Blankenfelde-Mahlow (DE)

(72) Inventors: Damir FILIPOVIC, München (DE); Stephan THESING, München (DE)

(21) Appl. No.: 18/504,150

(22) Filed: Nov. 7, 2023

(30) Foreign Application Priority Data
Nov. 8, 2022 (DE) 10 2022 129 504.4

(51) Int. Cl. H02K 5/22; B64D 27/24

(52) U.S. Cl. CPC H02K 5/225; B64D 27/24; H01R 29/00

(57) ABSTRACT

An electric drive unit for an aircraft includes an electric motor, a control system having a memory in which at least two different configurations are stored, and a plug connector that is connectable to a mating plug connector. The control system is configured to scan an identification on the plug connector, select one configuration of the at least two configurations based on the identification, and operate the electric motor using the selected one configuration.

This application claims the benefit of German Patent Application No. DE 10 2022 129 504.4, filed on Nov. 8, 2022, which is hereby incorporated by reference in its entirety.

### BACKGROUND

The present disclosure relates to an electric drive unit for an aircraft, to a system having a plurality of such electric drive units, and to an aircraft having at least one such electric drive unit.

Aircraft are propelled by various design concepts. Internal combustion engines (e.g., piston engines or gas turbine engines) allow long ranges and high speeds. Propulsion systems having one or a plurality of electric motor(s) allow the use of sustainably generated energy and are in some cases particularly low-maintenance and quiet. Advances in battery technology open up more and more fields of application of electric propulsion systems.

Electrically propelled aircraft, especially vertically taking off and landing aircraft (also abbreviated as eVTOL) are often equipped with a larger number of drive units than, for example, aircraft with one or a plurality of gas turbines as a propulsion system. For example, eVTOLs may have eight or ten separate drive units. These are often configured so as to be adapted to their installed position. For example, a different direction of rotation may be required, depending on the orientation at the respective installed position. However, this leads to a large number of differently designed and/or configured drive units, which in many cases is also associated with an increased probability of faults (e.g., in the wiring of the drive units).

DE 41 08 426 A1 relates to a device for switching the speed of an electric motor with a plug, which is connectable in different positions to the plug socket of the electric motor and thus generates different circuits of the motor windings and thus different motor speed stages depending on its inserted position.

CA 2292228 A1 describes a plug that is able be plugged into a drive unit in different positions in order to set different operating conditions. Another solution is described in U.S. Pat. No. 5,017,818 A.

However, the known solutions are limited in terms of the possibilities of their application.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, an electric drive unit that may be used as flexibly as possible is provided.

According to one aspect, an electric drive unit is provided (e.g., for an aircraft). The electric drive unit includes an electric motor, a control system having a memory, and a plug connector. The plug connector is connectable to a mating plug connector. At least two different configurations are stored in the memory. The saved configurations may be scannable, for example, by a processor of the electric drive unit. The control system is specified to scan an identification on the plug connector, select one configuration of the at least two configurations based on the identification, and operate the electric motor using the selected configuration.

This is based on the concept that the electric drive unit may in this way be adapted in a particularly simple and flexible manner to different applications (e.g., to different potential installed positions on an aircraft), in that a corresponding mating plug connector is plugged into the plug connector. By scanning the plug connector, the control system detects which one of the multiple saved configurations is selected. This may be done in a particularly simple way by applying a potential to a plug connector contact assigned to a configuration. Alternatively, the selection may be made using a pattern bearing on the contacts. Further, the selection may be made via a data transmission of an identification via the plug connector. This may be done, for example, through a component (such as an I2C EEPROM) in the plug connector, or via a communication channel (e.g., from a cockpit). This makes it easy to select a number of different configurations. However, the configuration itself is not transmitted via the plug connector, but only an identification of a configuration previously stored in the memory. This makes it possible to use electric drive units of identical construction in a plurality of positions and/or in a plurality of applications, while many sources of error that are usually present during installation may be eliminated. For example, eVTOLs with a comparatively large number of electric drive units may be manufactured particularly easily.

The two or more configurations may each contain one value or a plurality of values for one or a plurality of operating parameters. This makes it easy to make adjustments to specific applications, especially to specific installed positions.

The operating parameter(s) may include a direction of rotation, a maximum power, a maximum acceleration, a parameter of a feedback controller, and/or a parameter of an adjustable surface, such as a rotor blade with an adjustable blade angle. This allows for particularly efficient adjustment in a very simple way.

The electric drive unit may also include an inverter. The control system is optionally specified to adjust the inverter according to the selected configuration. This allows operation to be precisely adapted to the respective location of use.

The electric motor may include a plurality of parallel and independently energizable strands with wire windings (e.g., a plurality of independent three-phase winding systems). The two or more configurations herein may include different values in terms of the respective strands. This enables extensive configurations in a particularly simple way. For example, a strand may be deactivated in normal operation in a specific installed position. In contrast, all strands are activated at a different installed position.

The plug connector may be configured to supply the mating plug connector with a current. This provides that the mating plug connector may be particularly simple. For example, the mating plug connector is a dummy plug that only electrically connects certain contacts of the plug connector to one another depending on the configuration to be selected. Alternatively, the mating plug connector has electronics and optionally also a processor, whereby the mating plug connector communicates an identification to the control system via the plug connector.

The at least two configurations may each have an identification (e.g., a number), and the control system may be configured to scan an identification entered via the plug connector. This allows a large number of selectable configurations even with a plug connector of simple construction.

The plug connector may have a plurality of contacts that are contactable (e.g., electrically and/or optically) by corresponding counter contacts of the mating plug connector. This allows the selection to be transmitted reliably and efficiently.

Optionally, the control system is configured to select the configuration of the at least two configurations based on voltages applied to the contacts of the plug connector and/or based on data transmitted via the contacts. This allows the configuration to be selected quickly and reliably.

The electric drive unit may also include the mating plug connector. Optionally, a plurality of different mating plug connectors are provided, and the selection of the mating plug connector inserted into the plug connector leads to the selection of the configuration.

The mating plug connector may specify, for example, an installed position (e.g., one of a plurality of predetermined installed positions). In this way, electric propulsion devices of identical construction may be used at different positions.

The mating plug connector in a particularly simple design embodiment may have electrically connected contacts. The control system may scan which of the counter contacts are electrically connected to one another so as to select a configuration assigned to this connection.

Optionally, the mating plug connector for entering an identification to the plug connector is coupled to an input device. This allows further possibilities when selecting the configuration, which may also be dynamically adapted in this way (e.g., may be adapted during the ongoing operation).

According to one aspect, a system including a plurality of electric drive units (e.g., of identical construction) each according to any arbitrary design embodiment described herein is provided. As a function of their respective installed positions, the electric drive units are configured by corresponding mating plug connectors specific to the respective installed position. In terms of the advantages, reference is made to the above information.

According to one aspect, an aircraft including the electric drive unit and/or the system according to any design embodiment described herein is provided. The electric drive unit generates thrust and/or lift for the aircraft. In an aircraft, the above-mentioned benefits are particularly salient.

The mating plug connector for entering an identification to the plug connector may be electrically connected to an input device that is disposed in a cockpit of the aircraft. This allows further possibilities when selecting the configuration, which may also be dynamically adapted in this way (e.g., in the ongoing operation). For example, different mission configurations may be stored (e.g., one that is relatively more energy-efficient than another likewise stored mission configuration, such as with (intentionally) reduced maneuverability and/or performance (and thus a greater range with a battery charge)). If signals are received, for example, from the cockpit instead of the mating plug connector or in addition thereto, the pilot may select one of these configurations based on the planned mission. Optionally, the mating plug connector may be operatively connected to a component (e.g., disposed in the cockpit or at a location not accessible to the pilot), via which the configuration of the aircraft type is selected from an aircraft family and kept unchanged.

The aircraft may include a plurality of electric drive units that in turn renders the above benefits particularly salient.

### BRIEF DESCRIPTION OF THE DRAWINGS

FIG. 1 shows an aircraft in the form of an eVTOL aircraft having a plurality of electrically driven rotor units;

FIG. 2 shows an aircraft in the form of an airplane having an electrically driven rotor unit;

FIG. 3 shows an electrical propulsion system of the aircraft according to FIG. 1 and of the aircraft according to FIG. 2;

FIG. 4 shows an electric propulsion system for the aircraft according to FIG. 1 and the aircraft according to FIG. 2;

FIG. 5 shows a system having a plurality of electric drive units; and

FIG. 6 shows further details of an electric drive unit.

### DETAILED DESCRIPTION

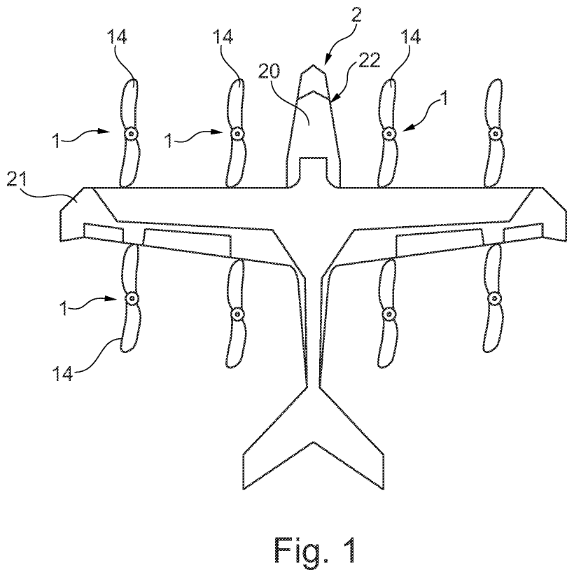

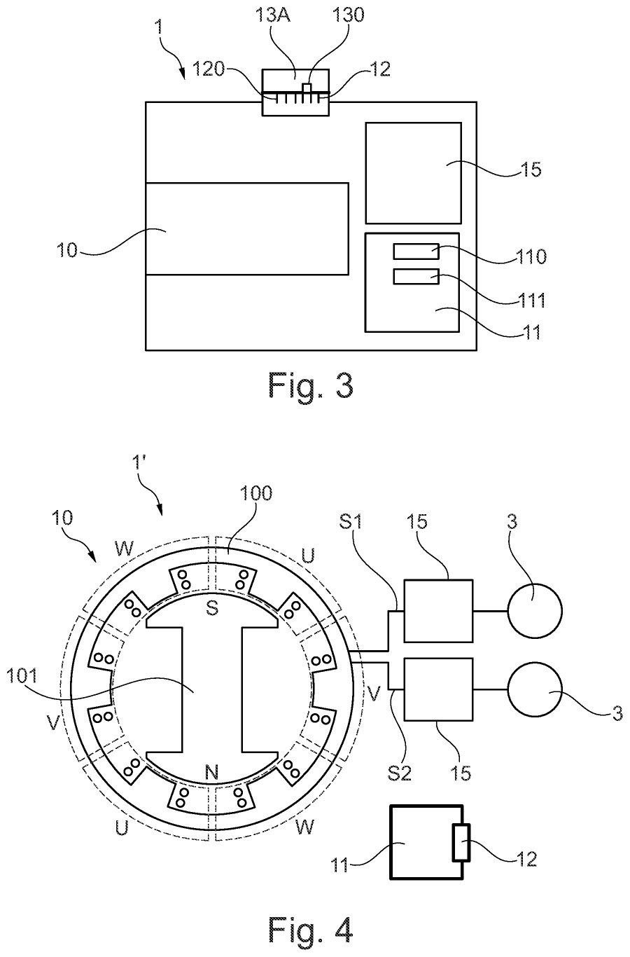

FIG. 1 shows an aircraft 2 having a plurality of rotor units 14. In the embodiment shown, the aircraft 2, by way of example, is configured as a vertical take-off and landing (VTOL) aircraft, specifically as an eVTOL aircraft. VTOL aircraft are configured for vertical take-off and landing. A VTOL aircraft particularly benefits from the advantages of the electric drive units described herein. The aircraft 2 includes a plurality of electric drive units 1 according to FIG. 3, explained hereunder, and alternatively or additionally, according to FIG. 4, explained further below.

The aircraft 2 includes a fuselage 20 with wings 21, on which two electric drive units 1 are in each case assembled at the front and the rear. At least some of the electric drive units 1 (e.g., the respective ones assembled at the front) are configured to be pivotable, so that it is possible to alternate between an orientation predominantly generating lift and an orientation predominantly generating thrust. The aircraft 2 also includes a cockpit 22.

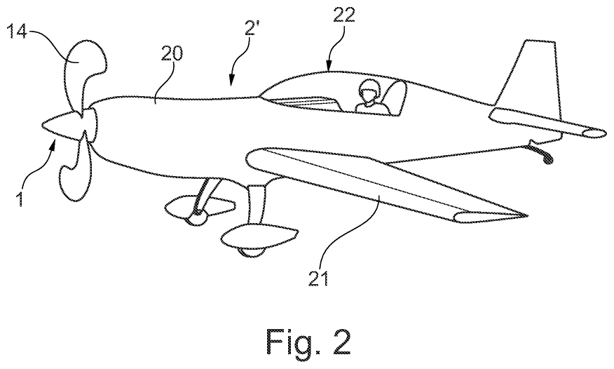

FIG. 2 shows an aircraft 2′ in the form of an electrically propelled aircraft with a fuselage 20, wings 21, and a cockpit 22.

The aircraft 2′ includes an electrical assembly 1 having a rotor unit 14 that is driven by an electric motor. The rotor unit 14 includes a plurality of rotor blades (e.g., two). In the example shown, the rotor blades are assembled on a hub and thus form a propeller. In alternative design embodiments, the aircraft 2′ includes a fan instead of a propeller and/or a plurality of electrical assemblies, each having at least one propeller or fan. This applies in an analogous manner to the electric drive units 1 of the aircraft 2 according to FIG. 1.

FIG. 3 shows an electric drive device 1 of the aircraft 2 according to FIG. 1, which in terms of construction is the same as that of the aircraft 2′ according to FIG. 2. The electric drive device 1 includes an electric motor 10 for driving a corresponding rotor unit 14, a control system 11 having a memory 110 and a processor 111, and a plug connector 12. At least two different configurations are stored in the memory 110. The configurations are therefore present in the form of software. The control system 11 herein is set up to scan an identification on the plug connector 12, to select one configuration of the at least two configurations based on the identification, and to operate the electric motor 10 using the selected configuration. Presently, the control system 11 is also specified to adjust an inverter 15 of the electric drive unit 1 according to the selected configuration. In the present example, for this purpose, a computer program is stored in the memory 110, which, when executed by the processor 111, performs the abovementioned acts.

The configurations may be stored in a separate file (e.g., a parameter data item (PDI) file, independently of a primary software of the electric drive unit 1. The primary software provides the functionality, and one or more PDIs may be stored and updated independently therefrom (e.g., and independently from one another), so that the functionality of the primary software does not need to be changed; only the corresponding parameter set is scanned and used by the primary software. A plurality of (e.g., all of) the electric drive units 1 may have the same primary software.

Each of the at least two configurations (e.g., three, four, five, ten, or more configurations) includes values for one or more operating parameters (e.g., for the electric motor 10 and for the inverter 15 of the electric drive device 1). The inverter 15 provides the electric motor 10 with an AC voltage. For example, the inverter 15 obtains a DC voltage and converts the DC voltage into the AC voltage.

The operating parameters include a direction of rotation (e.g., in which the electric motor 10 is to rotate), a maximum power of the electric motor and/or a maximum acceleration of the electric motor, and a parameter of a feedback controller (e.g., a PI feedback controller, such as of the inverter 15). Further, the operating parameters may include a parameter of an adjustable surface (e.g., in terms of an angle, such as a maximum angle, of attack of the rotor blades of the rotor unit 14). Further, the operating parameters may include compensation for manufacturing tolerances. The different configurations include comparatively different values for the operating parameters.

The plug connector 12 is connectable by plugging into to a mating plug connector 13A. The plug connector 12 has a plurality of contacts 120 that are contactable by counter contacts 130 of the mating plug connector 13A.

The control system 11 is configured to select the configuration of the at least two configurations based on signals present at the contacts 120 of the plug connector 12 (e.g., in the form of voltages and/or based on data transmitted via the contacts 120). In the example according to FIG. 3, the mating plug connector 13A is configured as a simple dummy plug and includes a bridge between two counter contacts 130. Here, for example, a potential is applied to one of the connected contacts 120 of the plug connector 12, which via the bridge, bears on another contact 120 of the plug connector 12. By plugging the mating plug connector 13A into the plug connector 12, the control system 11 may thus scan an identification thereon pertaining to which contact 120 the potential is located. Different mating plug connectors 13A may have a bridge to a respective different counter contact 130 and contact 120. Depending on which bridge the mating plug connector 13A is provided with, the control system 11 then selects a configuration assigned in a predetermined manner. In this example, the plug connector 12 is configured to supply the mating plug connector 13A with a voltage and a current.

Alternatively, the mating plug connector 13A has a power supply, and the control system 11 scans the voltage at the plug connector 12 in order to detect the identification. Further, via a transmission protocol or the like, an identification in the form of a data packet may be transmitted. This allows a large number of different identifications in association with a small requirement in terms of installation space.

In the present case, the aircraft 2 according to FIG. 1 at each installed location has a mating plug connector 13A specific to this installed location. Thus, a plurality of (e.g., eight) electric drive units 1 of identical construction may be assembled on the aircraft 2. The configuration of the electric drive units 1 is performed in a particularly simple manner by inserting the respective mating plug connectors 13A. Likewise, identical electric drive units may be used on different aircraft 2; 2′, where the configuration adapted for the respective aircraft 2; 2′ is selected via the mating plug connector 13A. In addition, each of the electric drive units 1 may identify itself and the respective installed location via this mating plug connector 13A and, optionally, report this identification when communicating with an aircraft main control unit or an indicator panel in the cockpit, so that the supplied data may be assigned to the respective electric drive unit 1 (e.g., when transmitting operating data, warnings, and the like).

Optionally, the electric motor 10 includes a plurality of parallel and independently energizable strands, also known as lanes. The electric motor 10 may in this instance also be referred to as a multi-lane electric motor. Each of the strands has wire windings. The at least two configurations have different values in terms of the respective strands. The electric motor 10 may thus be automatically configured in terms of the operation of the individual strands, depending on the installed location. For example, one strand may be deactivated at a specific installed position and used as a reserve. In addition, such multi-winding systems allow that in the event of many faults only part of the motor power is lost, and the remaining electric drive unit 1 may continue to supply a partial load.

FIG. 4 shows, in a schematic sectional representation, an electric motor 10 of an electric drive system 1 for the aircraft 2, 2′ according to FIGS. 1 and 2. The electric motor 10 is specifically configured in the form of a permanently excited synchronous machine. The embodiment shown in FIG. 4 is only an example, and drive motors of a different configuration may also be provided.

FIG. 4 shows that the electric motor 10 is presently configured as an internal rotor; however, this is to be understood as being merely an example. The electric motor 10 may likewise be an external rotor. The electric motor 10 includes a stator 100 that has an opening (e.g., through opening), not denoted, in which a rotor 101 is rotatably mounted.

The stator 100 includes a body (e.g., in the form of a laminated core), on which stator teeth are formed. The stator teeth protrude radially from the body (e.g., radially inwards). The stator 100 has stator windings that are wound about a plurality of the stator teeth. The stator windings are presently configured for three-phase operation (e.g., connected to a three-phase AC voltage with phases U, V, W). When the electric motor 10 is used for its intended purpose, the stator winding is accordingly impinged with the AC voltage.

The rotor 101 is configured as a salient pole rotor that includes permanent magnets for providing the magnetic flux. In the present embodiment, the rotor 101 has exactly one magnetic north pole N and one magnetic south pole S. In alternative embodiments, even more magnetic poles may be provided so as to alternate in the circumferential direction about a rotational axis of the rotor 101.

The rotor 101 is rotatably mounted. As a result of the three-phase AC voltage, the phases U, V, W thereof each being phase-shifted by 120°, a magnetic rotating field is generated in the intended operation, which interacts with the permanently excited magnetic field provided by the rotor 101, so that a corresponding rotational movement of the rotor 101 in relation to the stator 100 may be brought about during operation of the motor. Optionally, the electric motor 10 may be operated as a generator (e.g., for recuperation). The portions of the stator windings that are assigned to the respective phases U, V, W are schematically illustrated in FIG. 4.

The stator windings of the electric motor are divided into two parallel strands (e.g., lanes) and are in each case connected to one of two respective three-phase inverters 15 that are independent of one another. The inverters 15 provide the electric AC voltage with the three phases U, V, W. The inverters 15 obtain the electric energy required for the intended operation in each case from an energy source 3 connected to one (e.g., only one) of the two inverters 15. The energy sources 3 are electrically isolated from one another and may be operated independently of one another. In the present embodiment, each of the energy sources 3 is a DC voltage source that generates and/or stores electric energy and presently includes an electric energy storage device (e.g., an accumulator). Alternatively or additionally, the energy sources may include fuel cells, a combustion engine with a generator, and/or the like. Further, a common power source 3 may alternatively be provided for all inverters 15. Each inverter 15 includes (optionally) a feedback controller that scans the configuration of the inverter 15 from the mating plug connector 13A assigned to the inverter 15.

FIG. 4 illustrates that one of the inverters 15 is electrically connected to the stator windings of the first strand S1, and that the other inverter 15 is electrically connected to the stator windings of the second strand S2. The stator windings of the first strand S1 and the second strand S2 are presently each wound conjointly about the same stator teeth.

Alternatively, the electric motor has more than two strands (e.g., three or four strands), each of which is supplied with energy by other (not the same) inverters.

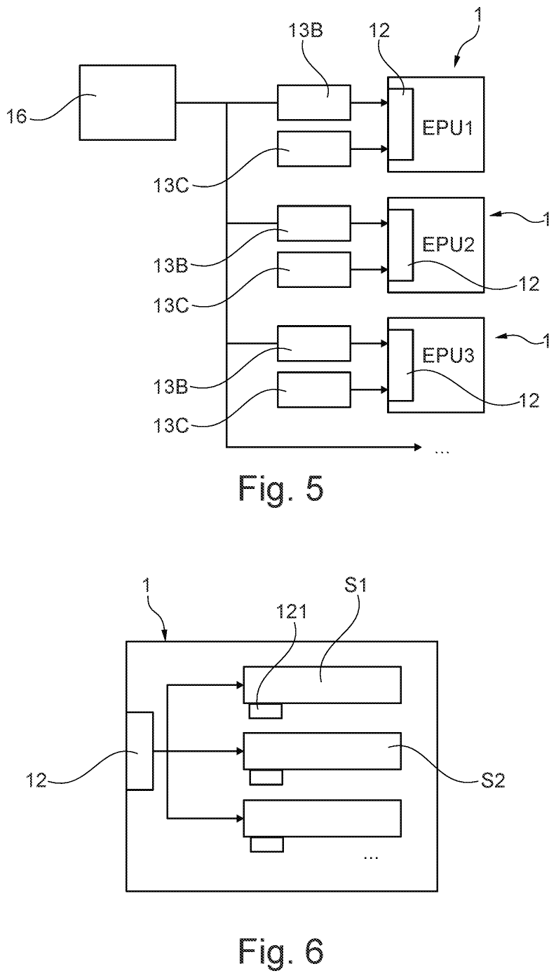

FIG. 5 shows a system having a plurality of electric drive units 1 (numbered as EPU 1, EPU 2 and EPU 3) that may be configured according to the electric drive unit 1 according to FIG. 3, or according to the electric drive unit 1′ according to FIG. 4. Each electric drive unit 1 includes the electric motor 10 and as many inverters as there are strands in the electric motor 10.

A first mating plug connector 13B and a second mating plug connector 13C may be connected to the plug connector 12 of each electric drive unit 1. The first and second mating plug connectors 13B, 13C may be configured separately from one another as shown; alternatively, the first and second mating plug connectors 13B, 13C are each configured in the form of a single mating plug connector having a first portion and a second portion.

The first mating plug connector 13B is in each case configured as described above (e.g., as a dummy plug). The second mating plug connector 13C of each electric drive unit 1 is electrically and/or communicatively connected to an input device 16. While the first mating plug connector 13B is in each case pre-configured and includes a fixedly adjusted identification, an identification may be adjusted by the input device 16 via the second mating plug connector 13C. The identification of the second mating plug connector 13C may supplement the identification of the first plug connector 13B.

The second mating plug connector 13C may thus be used to enter a location identification. The second mating plug connector 13C is therefore specific to the respective installed location. The first mating plug connector 13B may serve as a common configuration part that may be adjusted, for example, centrally (e.g., together with one or more further first mating plug connectors 13B, such as in the same manner; by a pilot or by a higher-level flight feedback controller, or fixedly adjusted for a respective aircraft type or a respective aircraft type subtype).

The control system 11 may scan the supplemented identification in the form of a combined identification, select a configuration of the at least two configurations based on the combined identification, and operate the electric motor 10 using the selected configuration. Again, the actual configurations have been previously saved in the memory 110; only the selection of a configuration is performed by the identification via the plug connector 12. The actual parameter values are therefore not transmitted via the plug connector 12. This enables a reduction of possible sources of error, which is of the utmost importance, for example, in the aviation sector.

The input device 16 is disposed in the cockpit 22 of the aircraft 2, for example. For example, a pilot may thus change the configuration of the electric drive unit 1 or the electric drive units 1 during flight. Alternatively or in addition, it may be provided that the configuration by a, for example, non-adjustable mating plug connector is fixedly adjusted for the respective aircraft type (e.g., by a central site) and is no longer changed during operation, which allows an aircraft manufacturer to optimally design its portfolio or an air carrier to optimally design its fleet.

For example, the plug connector 12 may have two, three, four, five or more contacts 120 (e.g., in the form of pins). Optionally, at least one contact 120 of the plug connector 12 is provided for a parity check; the at least one contact 120 may be referred to as the parity contact. For an aircraft (e.g., the aircraft 2) with eight electric drive units 1, three contacts 120 may be provided at the plug connector 12 for identification, as well as a parity contact.

FIG. 6 visualizes that, by the identification present at the plug connector 12, a plurality of (e.g., 2, 3 or more) strands S1, S2 of the electric motor 10 may be individually configured. The individual strands may thus be configured in a particularly simple and reliable manner, using the identification that may be entered at the plug connector 12. Optionally, one contact 120 is provided for each strand S1, S2.

Optionally, a separate part 121 of the plug connector 12 is provided for one, a plurality of, or, as in the example shown, for each of the strands S1, S2 of the electric motor 10. Each separate part 121 may be used to select a configuration specific to the respective strand S1, S2. The parts 121 may be disposed so as to be able to be plugged in conjointly or at a mutual spacing. This allows, for example, that each strand S1, S2 is identified. This identification may be used, for example, for communication via a communication bus or a communication network. Each part 121 may include one or more contacts 120, optionally in each case one parity contact.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. An electric drive unit for an aircraft, the electric drive unit comprising:
an electric motor;
a control system having a memory in which at least two different configurations are stored; and
a plug connector that is connectable to a mating plug connector,
wherein the control system is configured to:
scan an identification on the plug connector;
select one configuration of the at least two different configurations based on the identification; and
operate the electric motor using the selected one configuration.

2. The electric drive unit of claim 1, wherein each of the at least two different configurations comprises values for one or more operating parameters.

3. The electric drive unit of claim 2, wherein the one or more operating parameters comprise a direction of rotation, a maximum power, a maximum acceleration, a parameter of a feedback controller, a parameter of an adjustable surface, or any combination thereof.

4. The electric drive unit of claim 1, further comprising an inverter,
wherein the control system is further configured to adjust the inverter according to the selected one configuration.

5. The electric drive unit of claim 1, wherein the electric motor comprises a plurality of parallel and independently energizable strands with wire windings,
wherein the at least two configurations comprise different values in terms of respective strands of the plurality of parallel and independently energizable strands.

6. The electric drive unit of claim 1, wherein the plug connector is configured to supply the mating plug connector with a current.

7. The electric drive unit of claim 1, wherein the plug connector has a plurality of contacts that are contactable by counter contacts of the mating plug connector.

8. The electric drive unit of claim 7, wherein the control system is configured to select the one configuration of the at least two configurations based on voltages applied to the plurality of contacts of the plug connector, based on data transmitted via the plurality of contacts, or based on a combination thereof.

9. The electric drive unit of claim 1, further comprising the mating plug connector.

10. The electric drive unit of claim 9, wherein the mating plug connector indicates a mounting position.

11. The electric drive unit of claim 9, wherein the mating plug connector has electrically connected counter contacts.

12. The electric drive unit of claim 9, wherein the mating plug connector for entering an identification to the plug connector is coupled to an input device.

13. A system comprising:
a plurality of electric drive units of identical construction, each electric drive unit of the plurality of electric drive units being for an aircraft and comprising:
an electric motor;
a control system having a memory in which at least two different configurations are stored; and
a plug connector that is connectable to a mating plug connector,
wherein the control system is configured to:
scan an identification on the plug connector;
select one configuration of the at least two different configurations based on the identification; and
operate the electric motor using the selected one configuration, and
wherein the plurality of electric drive units, as a function of respective installed positions, are configured by corresponding mating plug connectors.

14. An aircraft comprising:
an electric drive unit comprising:
an electric motor;
a control system having a memory in which at least two different configurations are stored; and
a plug connector that is connectable to a mating plug connector,
wherein the control system is configured to:
scan an identification on the plug connector;
select one configuration of the at least two different configurations based on the identification; and
operate the electric motor using the selected one configuration.

15. The aircraft of claim 14, further comprising:
a plurality of additional electric drive units of identical construction as the electric drive unit,
wherein the electric drive unit and the plurality of additional electric drive units, as a function of respective installed positions, are configured by corresponding mating plug connectors, the corresponding mating plug connectors including the mating plug connector.

16. The aircraft of claim 14, wherein the mating plug connector for entering an identification to the plug connector is electrically connected to an input device that is disposed in a cockpit of the aircraft.
